(19) United States
(12) Patent Application Publication
(10) Pub. No.: US 2013/0092252 A1
(43) Pub. Date: Apr. 18, 2013

(54) HOUSING FOR A HYDRAULIC UNIT

(71) Applicant: Marc Gareis, Leonberg (DE)

(72) Inventor: Marc Gareis, Leonberg (DE)

(73) Assignee: LOESOMAT Schraubtechnik Neef GmbH, Vaihingen/Enz (DE)

(21) Appl. No.: 13/641,302

(22) PCT Filed: Apr. 6, 2011
(86) PCT No.: PCT/DE2011/000362

§ 371 Date: Dec. 5, 2012

(30) Foreign Application Priority Data
Apr. 16, 2010 (DE) 10 2010 015 496.2

(51) Int. Cl. F16K 27/00

(52) U.S. Cl. CPC F16K 27/00
USPC 137/343

(57) ABSTRACT

A housing (100) for a hydraulic unit is characterized by a housing wall (101) which is closed on all sides and in which at least one inlet opening (110) and at least one fan (121), which can be operated independently of the hydraulic unit (400), are arranged.

The invention relates to a housing for a hydraulic unit.

Hydraulic units, especially high-pressure hydraulic units, are generally used for driving hydraulically piston-actuated torque screwdrivers (so-called power screwdrivers). Furthermore, they are used the tensioning strain cylinders and the like. There are so-called single-tube systems in which the forward stroke occurs by means of hydraulic force and the return stroke occurs in this case by means of spring force. They are also systems in which both the forward stroke and the return stroke of the piston occur by means of hydraulic force.

Such high-pressure hydraulic units are driven by means of electric motors or pneumatic motors. Brushless DC motors or also three-phase current motors and so-called sub-oil motors are used. It is known from the state of the art to provide these systems for protection with a so-called tubular frame. It mostly encloses the motor and the control elements. At the same time, it is used for accommodating connecting cables and the cables for the remote control.

It is problematic in this case that such a tubular frame does not offer any protection against protruding obstructions, which occur for example when the hydraulic unit needs to be pulled on a cable to a workplace, e.g. by means of a crane. It frequently occurs that especially the tube connections are bent or torn off. Furthermore, damage to the electrical leads and the mains connections etc occurs.

It is a further disadvantage that a tubular frame structure does not offer any protection against hydraulic fluid that ejects under high pressure. If a component for example is damaged as a result of external or internal action and if hydraulic fluid ejects under high pressure, there is a considerable likelihood of injury since a liquid jet develops an immense cutting effect under very high pressure.

A relevant problem of a hydraulic unit with such a tubular frame is represented by the cooling of the drive motor and the hydraulic oil. The hydraulic oil will become very hot during operation and can reach temperatures of up to 100° C. and more. This very often leads to the consequence that the units are forcibly switched off in order to produce cooling of the oil to a permissible maximum temperature. Such a forced shut-off is disadvantageous during the operation of the hydraulic unit. These units are often only cooled by convection.

The present invention is therefore based on the object of providing a housing for such a hydraulic unit which generally offers better protection of the units and the attached parts such as pressure gauges, valves and tube connections against external influences. The housing shall further protect an operator from injury in case of a leakage. It is a relevant object to provide improved cooling of the unit for extending its service life.

This object is achieved in accordance with the invention by a housing for a hydraulic unit which is characterized by a housing wall which is closed on all sides, in which at least one inlet opening and at least one fan that can be operated independently of hydraulic unit are arranged. A fan that can be operated independently from the hydraulic unit shall mean in a way a “separately driven fan”, i.e. a fan that can be actuated even when the hydraulic unit is not switched on for example. The operation of the fan therefore does not depend on the operation of the hydraulic unit and its functionality, which represents an autonomous system instead. As a result of the arrangement of the housing as closed walls with at least one opening and at least one fan arranged therein, a purposeful air flow through the housing can be achieved, with the housing simultaneously protecting the unit and the attached parts against external damage and protecting an operator from hydraulic oil escaping under high pressure.

As a result of the measures stated in the dependent claims, advantageous further developments and improvements of the apparatus stated in the independent claim are enabled. A highly advantageous embodiment provides that the at least one fan sucks in ambient air through the housing. Although it is principally possible to operate the fan in such a way that it blows ambient air into the housing, this would lead to a turbulent flow in the housing however. The air flow would swirl and would need to exit again by the one or several opening(s) arranged in the housing wall. Cooling can be achieved in a substantially more effective way in that the air flow is sucked through the housing. In this case, the at least one fan sucks air from the interior of the housing to the outside into the ambient environment. As a result of the negative pressure produced thereby, air flows from the ambient environment through the at least one inlet opening into the housing. A purposeful flow is achieved in this way, which enables a substantially more effective cooling of the hydraulic unit and its components.

In order to adjust the flow optimally to the cooling requirements, it can be provided to adjust the size of the at least one opening to a predetermined air flow.

It is further advantageously provided that the at least one opening and the at least one fan are arranged in the wall of the housing in such a way that the longest possible air flow through the housing is produced, with the flowing air being guided past the hydraulic unit and its components.

In order to produce several air flows, a plurality of openings disposed at different positions in the housing wall can further be provided according to one embodiment. In this case, the at least one fan produces several flows guided towards the fan, which flows allow purposeful flows over different parts of hydraulic unit or its components due to the positioning of openings in the housing wall.

It can be provided according to a further embodiment that a plurality of fans arranged at different positions on the housing wall is also provided. In this case, all fans can be operated separately from one another and therefore represent “separately driven fans” within the terms as explained above. The cooling effect is further enhanced thereby.

The housing wall can principally be arranged in a variety of materials. It is possible to use high-strength plastic materials or composite materials. An advantageous embodiment provides the use of metal which can especially be processed in a simple way. Electrical connections or hydraulic connections are arranged in the housing wall, which occurs in such a way that damage is avoided to the highest possible extent. The connections are integrated in the housing wall. Furthermore, display elements such as gauges can be integrated in the housing wall.

Further advantages and features of the invention will be explained below in conjunction with the drawing, in which

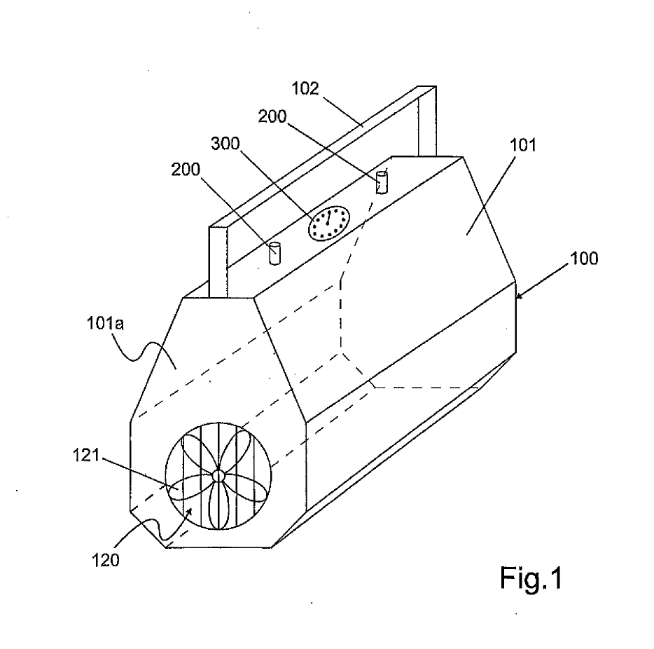

FIG. 1 schematically shows an isometric view of a housing in accordance with the invention and

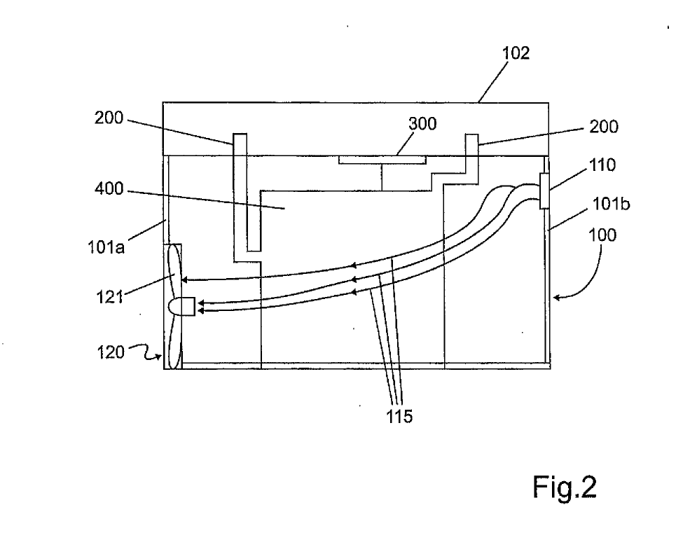

FIG. 2 schematically shows a sectional view of the housing in accordance with the invention.

A housing which utilizes the invention, is designated in its entirety with reference numeral 100 and is shown in FIG. 1 and FIG. 2 comprises a wall 101 which is closed on all sides and is especially made of metal. The housing can substantially have the outer shape of a bag with a handle 102 arranged at the upper end. The connections 200 for the hydraulic lines and/or the electric lines are disposed beneath the handle 102 and are protected to a certain extent by said handle. Furthermore, display elements 300 such as gauges for example can be integrated in the upper part of the housing or at another location in the housing wall 301.

An opening 120 for a fan 121 is provided in a front housing wall 101a on the face side. At least one inlet opening 110 is arranged on the other front housing wall 101b which is opposite of said housing wall 101a.

The inlet opening 110 and the opening 120 for the fan 121 are positioned in such a way that the longest possible air flow and air guidance over a hydraulic unit 400 which is arranged in the housing 100 are produced. The fan 121 is operated in such a way that it extracts air by suction from the interior of the housing 100 to the ambient environment. As a result of this suction process, a negative pressure is produced in the interior of the housing 100. Air flows in this way from the ambient environment through the opening 110 into the housing 100 and it is guided around the hydraulic unit 400 until it flows out again from the fan opening 120. Such an operation of the fan 121 allows a purposefully guidable flow which enables a substantially more effective cooling of the hydraulic unit 400 as compared with a conversely operated fan, i.e. a fan which blows air into the interior of the housing.

The strength of the air flow can be determined by varying the size of the opening 110. Furthermore, more than one opening 110 can be provided in the housing wall 101b or any location other than the housing wall 121. it is further also possible to provide more than one fan in the housing wall 101. Optimal cooling of the hydraulic unit 400 is enabled by the air flow guided as a result of suction effect.

1. A housing (100) for a hydraulic unit, comprising a housing wall (101) which is closed on all sides and in which at least one inlet opening (110) and at least one fan (121) are arranged, which fan can be operated independently of the hydraulic unit (400).

2. A housing (100) according to claim 1, wherein the at least one fan (101) sucks in ambient air through the housing (100).

3. A housing (100) according to claim 1, wherein the opening cross section of the at least one opening (110) can be adjusted to a predeterminable air flow.

4. A housing (100) according to claim 1, wherein the at least one opening (110) and the at least one fan (121) are arranged in the housing wall (101) in such a way that the longest possible flow guidance through the housing is obtained.

5. A housing (100) according to claim 1, wherein a plurality of openings (110) is provided, which are arranged at different positions in the housing wall (101).

6. A housing (100) according to claim 1, wherein a plurality of fans (121) is provided, which are arranged at different positions in the housing wall.

7. A housing according to claim 1, wherein the housing wall (101) consists of high-strength plastic and/or composite materials and/or metal.

8. A housing according to claim 1, wherein the connections (200) for hydraulic lines and electric lines are provided in the housing wall (101).

9. A housing according to claim 1, wherein the display instruments, especially pressure gauges (300), are arranged in the housing wall.
